(19) United States
(12) Patent Application Publication
(10) Pub. No.: US 2017/0126169 A1
(43) Pub. Date: May 4, 2017

(54) GRID-LITE ROOF SYSTEM FOR SOLAR PANEL INSTALLATIONS

(71) Applicant: Gamechange Solar LLC, New York, NY (US)

(72) Inventor: Andrew Barron Worden, New York, NY (US)

(21) Appl. No.: 15/342,504

(22) Filed: Nov. 3, 2016

Related U.S. Application Data
(60) Provisional application No. 62/250,059, filed on Nov. 3, 2015.

(51) Int. Cl. H02S 20/24; E04D 13/00

(52) U.S. Cl. CPC H02S 20/24; E04D 13/00

(57) ABSTRACT

A mounting system for mounting a solar panel on a flat roof surface includes plurality of first rails each extend along a first axis, each of the first rails comprising a first web and first and second flanges extending from the first web, a first lip extending outwardly from a distal end of the first flange, and a second lip extending outwardly from a distal end of the second flange. A plurality of second rails each extend transverse to the first axis, each of the second rails comprising a second web and third and fourth flanges extending from the second web, a third lip extending outwardly from a distal end of the third flange, and a fourth lip extending outwardly from a distal end of the fourth flange. A plurality of third rails each extending transverse to the first axis and parallel to the plurality of second rails, each of the third rails comprising a third web and fifth and sixth flanges extending from the third web, a fifth lip extending outwardly from a distal end of the fifth flange, and a sixth lip extending outwardly from a distal end of the sixth flange. The first and second lips are in face-to-face contact with the third and fourth lips, and the first and second lips are in face-to-face contact with the fifth and sixth lips, the first rails are closer to the flat roof surface than the second and third rails.

### CROSS-REFERENCE TO RELATED APPLICATION

This application claims priority from the provisional application designated Ser. No. 62/250,059 filed Nov. 3, 2015 and entitled “Grid-Lite Roof System for Solar Panel Installations”, and is hereby incorporated by reference.

### BACKGROUND OF THE INVENTION

1. Technical Field

This disclosure relates generally to a solar panel installation and, more particularly, to apparatuses and assemblies for use in a solar panel installation on a flat roof.

2. Background Information

Large-scale solar panel arrays are currently provided with two major types of support systems. A first type is referred to as a roof system, which, as the name implies, embodies relatively light structures which are integrated with rooftops and roofing structures. These structures are limited in size as a function of rooftop areas and roof support capabilities

A second major type of support system is referred to as a “ground system”, which, as opposed to roof systems, can be and often is quite extensive in area (solar panels provide energy as a function of areal sunlight capture and require large areas for viable energy production) and which are accordingly difficult to protect and are highly susceptible to weather conditions. In particular, high or sustained wind conditions may either damage solar panels over time or, more commonly, cause the panels to move out of optimal position for sunlight capture.

Typically, solar panel arrays comprise flat solar panels arranged on supporting structures usually of a fixed grid nature. The supporting structures are configured to hold the panels at an angle relative to the supporting ground such that the solar panels optimally face and capture sunlight for maximum energy conversion.

Because of the extensive area occupied by viable energy producing solar panels and the large number of panels typically used, efficiencies of scale and proper deployment present numerous problems.

### SUMMARY OF THE DISCLOSURE

According to an aspect of the present disclosure, a mounting system for mounting a solar panel on flat roof surface is provided. The mounting system includes a plurality of first rails each extending along a first axis. Each of the first rails comprising a first web and first and second flanges extending from the first web to faint a first C-section. A first lip extends outwardly from a distal end of the first flange, and a second lip extends outwardly from a distal end of the second flange. The mounting system also includes a plurality of second rails each extending transverse to the first axis. Each of the second rails comprising a second web and third and fourth flanges extending from the second web to form a second C-section. A third lip extends outwardly from a distal end of the third flange, and a fourth lip extending outwardly from a distal end of the fourth flange. The mounting system further comprises a plurality of third rails each extending transverse to the first axis and parallel to the plurality of second rails, each of the third rails comprising a third web and fifth and sixth flanges extending from the third web to form a third C-section. A fifth lip extends outwardly from a distal end of the fifth flange, and a sixth lip extends outwardly from a distal end of the sixth flange. A plurality of panel supports, each having a first base and a second base having a planar surface. Each of the panel supports is configured to attach to at least one of the first rails and each of the panel supports includes a solar panel resting surface that is transverse with respect to the planar surface. At least one of the first rails is attached transversely to at least one of the second rails via a first fastener that extends through the first lip and the third lip, and via a second fastener that extends through the second lip and the fourth lip. At least one of the first rails is attached transversely to at least one of the third rails via a third fastener that extends through the first lip and the fifth lip, and via a fourth fastener that extends through the second lip and the sixth lip. The first and second lips are in face-to-face contact with the third and fourth lips, and the first and second lips are in face-to-face contact with the fifth and sixth lips. The first rails are closer to the flat roof surface than the second and third rails.

A solar panel may be mounted to the panel support such that the solar panel rests on the panel surface to angle the solar panel with respect to the planar surface.

The first and second lips may each include a plurality of through holes.

The first, second, third and fourth lips may each include a plurality of through holes.

The first, second, third, fourth, fifth and sixth lips may each include a plurality of through holes.

Each of the plurality of panel supports may include a wind deflector mounting surface.

A wind deflector panel may be mounted to a first wind deflector mounting surface on a first panel support and to a second wind deflector mounting surface on a second first panel support.

According to another aspect of the present disclosure, a mounting system for mounting a solar panel on a flat roof surface is provided. The mounting system comprising a plurality of first rails each extending along a first axis, each of the first rails comprising a first web and first and second flanges extending from the first web, a first lip extending outwardly from a distal end of the first flange, and a second lip extending outwardly from a distal end of the second flange. The mounting system also includes a plurality of second rails each extending transverse to the first axis, each of the second rails comprising a second web and third and fourth flanges extending from the second web. A third lip extends outwardly from a distal end of the third flange, and a fourth lip extends outwardly from a distal end of the fourth flange.

A plurality of third rails each extends transverse to the first axis and parallel to the plurality of second rails, each of the third rails comprising a third web and fifth and sixth flanges extending from the third web. A fifth lip extending outwardly from a distal end of the fifth flange, and a sixth lip extending outwardly from a distal end of the sixth flange. The mounting system also includes a plurality of panel supports, each having a first base and a second base having a planar surface, where each of the panel supports is configured to attach to at least one of the first rails and each of the panel supports includes a solar panel resting surface that is transverse with respect to the planar surface.

Each of the first rails is attached transversely to at least one of the second rails and at least one of the third rails, such that the first and second lips are in face-to-face contact with the third and fourth lips, and the first and second lips are in face-to-face contact with the fifth and sixth lips. The first rails are closer to the flat roof surface than the second and third rails.

The foregoing features and the operation of the invention will become more apparent in light of the following description and the accompanying drawings.

### BRIEF DESCRIPTION OF THE DRAWINGS

FIG. 1A is a partial, perspective pictorial illustration mounting system for mounting a solar panel; FIG. 1B is a cross-sectional illustration of a first rail of the mounting system.

FIGS. 2A and 2B illustrate a first rail being mounted to a second rail.

FIG. 3A is a pictorial illustration of the first, second and third rails with a panel support mounted to the first rail; FIG. 3B is a detail illustration of a portion of the third rail.

FIG. 4 is an illustration of a panel support being mounted to the first rail at a first base surface and at a second base surface of the panel support.

FIGS. 5A and 5B illustrate side views of a solar panel mounted to a solar panel rest surface of a panel support; FIG. 5A illustrates the panel support mounted to the solar panel at about a 5 degree angle relative to the flat roof; FIG. 5B illustrates the panel support mounted to the solar panel at about a 10 degree angle relative to the flat roof.

FIG. 6A illustrates a wind deflector mounted to the panel support; FIG. 6B is a detailed view of a portion of the wind deflector fastened to the panel support.

FIG. 7A illustrates the mounting system with fire guards mounted to the second and third rails; FIG. 7B illustrates a flange surface of the fire guard fastened to lips of the second and third rails.

### DETAILED DESCRIPTION

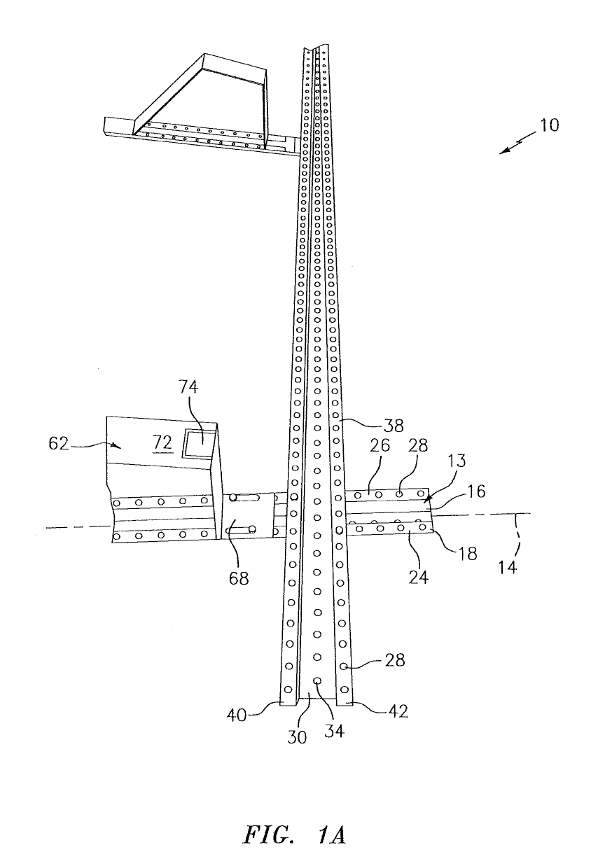

FIG. 1A illustrates a mounting system 10 for mounting a solar panel (not shown) on a flat roof surface 12. The mounting system 10 comprises a plurality of first rails 13 each extending along a first axis 14. FIG. 1B is a cross-sectional illustration of a first rail 13. Referring to FIGS. 1A and 1B, each of the first rails 13 comprises a first web 16 and first and second flanges 18, 20 respectively, extending from the first web 16 to form a first C-section. A first lip 24 extends outwardly from a distal end of the first flange 18, and a second lip 26 extends outwardly from a distal end of the second flange 20. Referring to FIG. 1A, the first and second lips 24, 26 each include a plurality of through holes 28 (e.g., equally spaced apart). The web 16 also includes a plurality of web through holes 30 (e.g., equally spaced apart). The first rails may be fastened to the flat roof surface using fasteners, et cetera, preferably in a way the does not degrade the integrity of the roof, or a warranty thereon. The rails may be made of galvanized steel (e.g., G90). However, it is contemplated that the rails may be made of any high strength, non-corrosive, weather resistant material, including metallic (e.g., magni coated or stainless steel) and non-metallic materials.

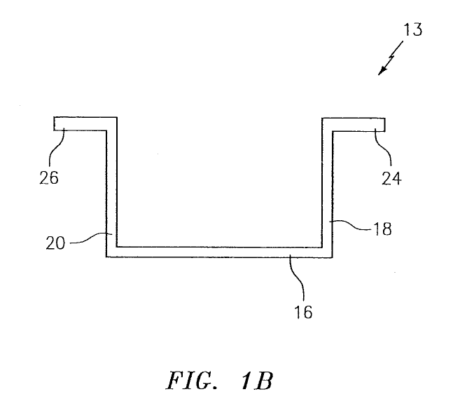

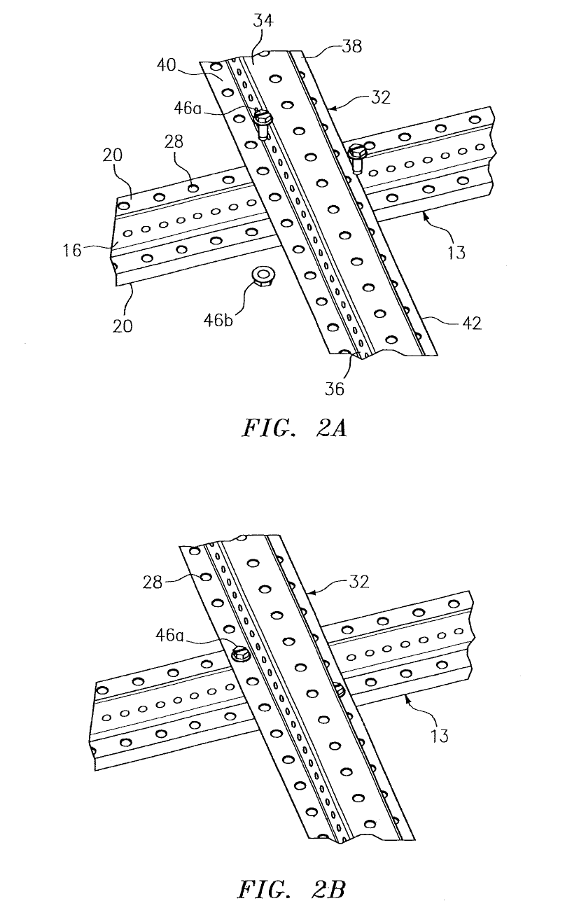

Referring to FIGS. 1A, 2A and 2B, the mounting system 10 also includes a plurality of second rails 32 each extending transverse (e.g., a right angle to) to the first axis 14 (FIG. 1A), each of the second rails 32 comprising a second web 34 and third and fourth flanges 36, 38, respectively, extending from the second web 34 to form a second C-section. A third lip 40 extends outwardly from a distal end of the third flange 36, and a fourth lip 42 extends outwardly from a distal end of the fourth flange 38. Fasteners such as 46a, 46b may be used to secure the rails via the through holes in the lips.

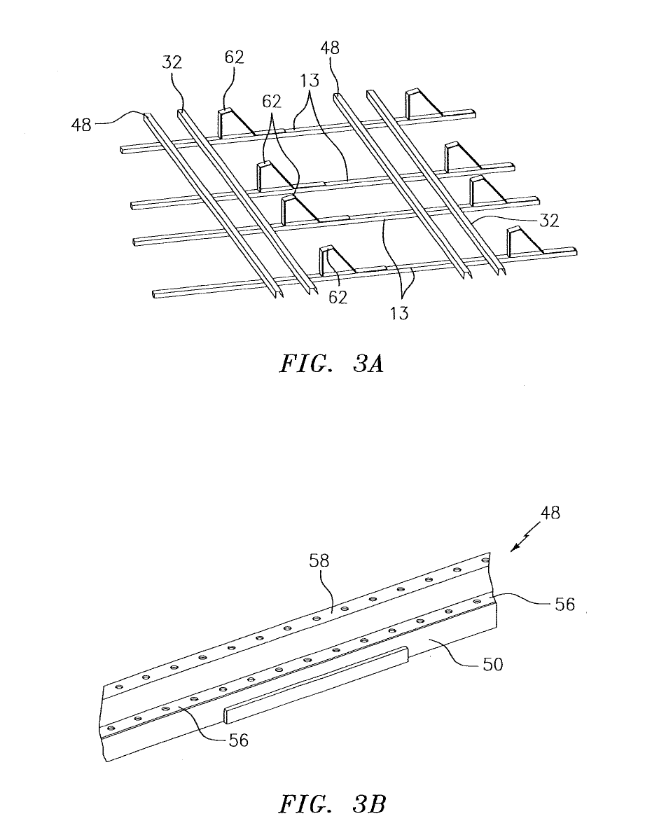

Referring to FIG. 3A, a plurality of third rails 48 extends transverse to the first axis and parallel to the second rails 32. Referring to FIGS. 3A and 3B, each of the third rails 48 comprising a third web and fifth and sixth flanges 50, 52 respectively, extending from the third web to form a third C-section 54. A fifth lip 56 extends outwardly from a distal end of the fifth flange 50, and a sixth lip 58 extends outwardly from a distal end of the sixth flange 52. The first, second and third rails may have a similar design. In an alternative embodiment the second and third rails may be configured as I-beams. A panel support surface 62 may be fastened to each of the first rails 13 in a manner similar to the fastening the first and second rails, as shown for example in FIGS. 2A and 2B.

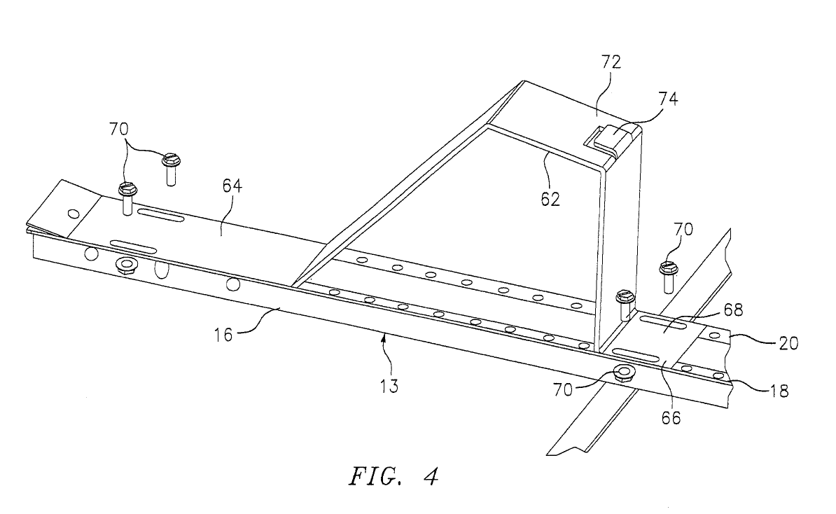

FIG. 4 illustrates the panel support 62 mounted to the first rail 13. The panel support includes a first base 64 and a second base 66 having a planar surface 68. The panel support 62 is fastened to the first rail 13, for example with fasteners 70. The panel support includes a solar panel resting surface 72 that is transverse with respect to the roof surface. The solar panel (not shown) may clip 74 into the solar panel to lock it in place, by for example sliding the backside of the panel along the surface 72 until it engages the clip 74.

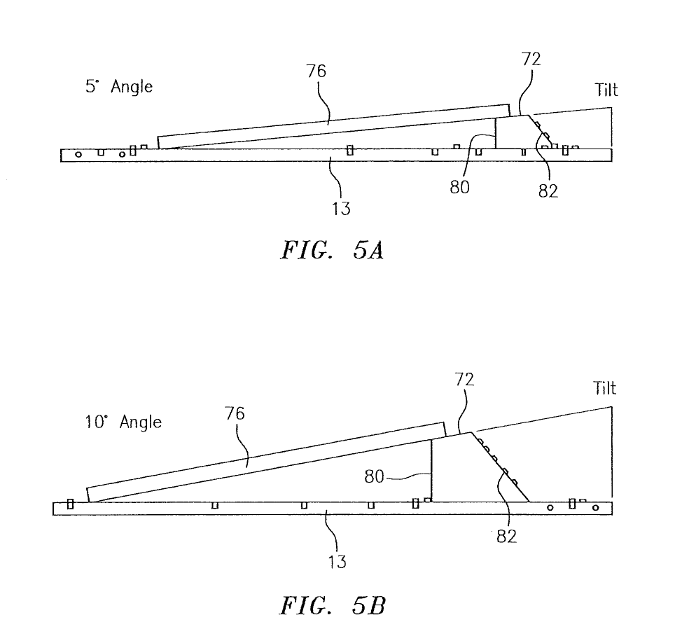

FIGS. 5A and 5B illustrate side views of a solar panel 76 mounted on the solar panel rest surface 72 of a panel support 62. FIG. 5A illustrates the panel rest surface 72 oriented/sloped to mount the solar panel 76 at about a 5 degree angle relative to the flat roof. FIG. 5B illustrates the panel rest surface 72 oriented/sloped to mount the solar panel 76 at about a 10 degree angle relative to the flat roof. One ordinary skill in the art will appreciated that the length and orientation of side walls 80, 82 may be selected to provide the desired plane for the panel rest surface, and thus the tilt angle of the solar panel with respect to the roof.

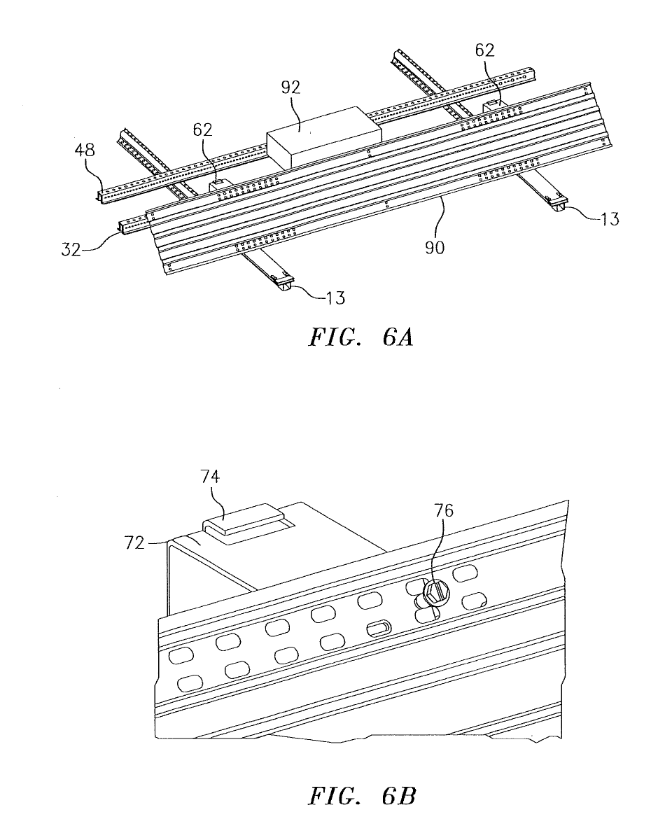

FIG. 6A illustrates a wind deflector 90 mounted to the panel supports 62. FIG. 6B is a detailed view of a portion of the wind deflector 90 fastened to one of the panel supports 62 with a fastener. The surface of the wind deflector includes a plurality of through holes and the panel deflects the wind so as not to damage the solar panel. As illustrated in FIG. 6A, a ballast 92 may be placed along the second and third rails.

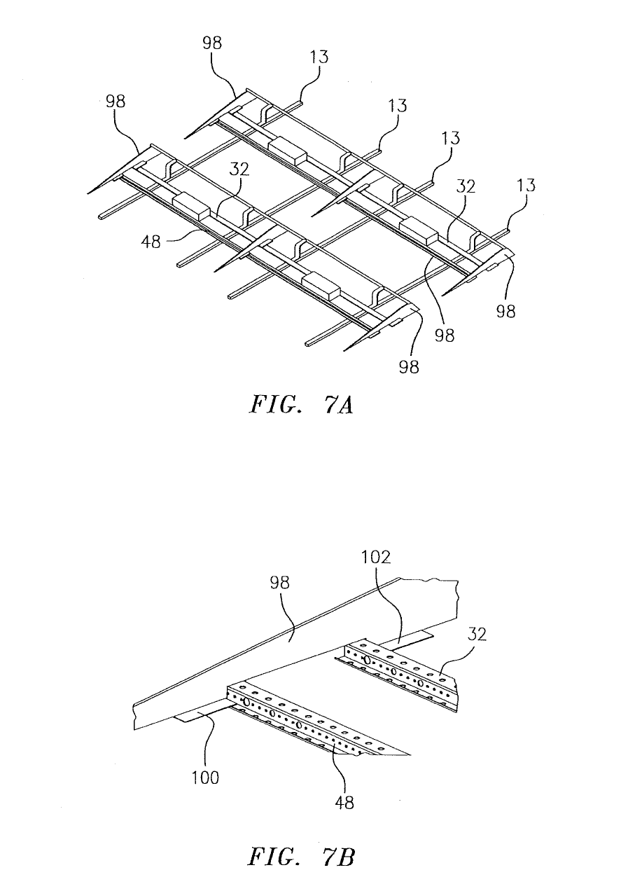

FIG. 7A illustrates the mounting system with fire guards 98 mounted to the second and third rails 32, 48. FIG. 7B illustrates a flange surfaces 100, 102 of one of the fire guards 98 fastened to lips of the second and third rails 32, 48.

Referring again to FIGS. 1A, 2A and 2B the first rail 13 is attached transversely to at least one of the second rails 32 via a first fastener that extends through the first lip and the third lip, and via a second fastener that extends through the second lip and the fourth lip.

The first and second rails may be fastened such that the first and second lips of the first rail are in face-to-face contact with the third and fourth lips of the second rail. Similarly, first and second lips of the first rail may be in face-to-face contact with the fifth and sixth lips of the third rail. It is contemplated and one of ordinary skill in the art will recognize that numerous fastening techniques may be used to secure the second and third rails to the first rail.

In a preferred embodiment the first rail is closer to the flat roof surface than the second and third rails.

An exemplary embodiment of such a solar panel installation is the Grid-Lite™ roof mounting system designed by the assignee of the present invention, GameChange Racking of New York City, N.Y. Of course, the solar panel installation of the present disclosure is not limited to the specific exemplary embodiment detailed in herein. For examples, one or more system components may be swapped out for components with alternate configurations, one or more the components may be omitted and/or the mounting system may be modified to include one or more additional components not specifically described herein.

While various embodiments of the present invention have been disclosed, it will be apparent to those of ordinary skill in the art that many more embodiments and implementations are possible within the scope of the invention. For example, the present invention as described herein includes several aspects and embodiments that include particular features. Although these features may be described individually, it is within the scope of the present invention that some or all of these features may be combined with any one of the aspects and remain within the scope of the invention. Accordingly, the present invention is not to be restricted except in light of the attached claims and their equivalents.

What is claimed is:

1. A mounting system for mounting a solar panel on a flat roof surface, the mounting system comprising:
plurality of first rails each extending along a first axis, each of the first rails comprising a first web and first and second flanges extending from the first web to form a first C-section, a first lip extending outwardly from a distal end of the first flange, and a second lip extending outwardly from a distal end of the second flange;
a plurality of second rails each extending transverse to the first axis, each of the second rails comprising a second web and third and fourth flanges extending from the second web to form a second C-section, a third lip extending outwardly from a distal end of the third flange, and a fourth lip extending outwardly from a distal end of the fourth flange;
a plurality of third rails each extending transverse to the first axis and parallel to the plurality of second rails, each of the third rails comprising a third web and fifth and sixth flanges extending from the third web to form a third C-section, a fifth lip extending outwardly from a distal end of the fifth flange, and a sixth lip extending outwardly from a distal end of the sixth flange;
a plurality of panel supports, each having a first base and a second base having a planar surface, where each of the panel supports is configured to attach to at least one of the first rails and each of the panel supports includes a solar panel resting surface that is transverse with respect to the planar surface;
where least one of the first rails is attached transversely to at least one of the second rails via a first fastener that extends through the first lip and the third lip, and via a second fastener that extends through the second lip and the fourth lip, and the least one of the first rails is attached transversely to at least one of the third rails via a third fastener that extends through the first lip and the fifth lip, and via a fourth fastener that extends through the second lip and the sixth lip,
such that the first and second lips are in face-to-face contact with the third and fourth lips, and the first and second lips are in face-to-face contact with the fifth and sixth lips; and
the first rails are closer to the flat roof surface than the second and third rails.

2. The flat roof top solar panel mounting system of claim 1, further comprising a solar panel that is mounted to the panel support such that the solar panel rests on the panel surface to angle the solar panel with respect to the planar surface.

3. The flat roof top solar panel mounting system of claim 2, where the first, second, third, fourth, fifth and sixth lips each include a plurality of through holes.

4. The flat roof top solar panel mounting system of claim 3, where each of the plurality of panel supports includes a wind deflector mounting surface.

5. The flat roof top solar panel mounting system of claim 4, further comprising a wind deflector panel that is mounted to a first wind deflector mounting surface on a first panel support and to a second wind deflector mounting surface on a second first panel support.

6. A mounting system for mounting a solar panel on a flat roof surface, the mounting system comprising:
plurality of first rails each extending along a first axis, each of the first rails comprising a first web and first and second flanges extending from the first web, a first lip extending outwardly from a distal end of the first flange, and a second lip extending outwardly from a distal end of the second flange;
a plurality of second rails each extending transverse to the first axis, each of the second rails comprising a second web and third and fourth flanges extending from the second web, a third lip extending outwardly from a distal end of the third flange, and a fourth lip extending outwardly from a distal end of the fourth flange;
a plurality of third rails each extending transverse to the first axis and parallel to the plurality of second rails, each of the third rails comprising a third web and fifth and sixth flanges extending from the third web, a fifth lip extending outwardly from a distal end of the fifth flange, and a sixth lip extending outwardly from a distal end of the sixth flange;
a plurality of panel supports, each having a first base and a second base having a planar surface, where each of the panel supports is configured to attach to at least one of the first rails and each of the panel supports includes a solar panel resting surface that is transverse with respect to the planar surface;
where least one of the first rails is attached transversely to at least one of the second rails and at least one of the third rails, such that the first and second lips are in face-to-face contact with the third and fourth lips, and the first and second lips are in face-to-face contact with the fifth and sixth lips; and
the first rails are closer to the flat roof surface than the second and third rails.
